(19) United States
(12) Patent Application Publication
(10) Pub. No.: US 2009/0083703 A1
(43) Pub. Date: Mar. 26, 2009

(54) Electronic Clinical Study Site Generation System

(75) Inventors: Paul Grady, Reno, NV (US); Ryan Anderson, Eden Prairie, MN (US); Kelly Domalik, Plymouth, MN (US); Melchizedek Mauleon, Plymouth, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: MedNet Solutions, Minnetonka, MN (US)

(21) Appl. No.: 12/237,222

(22) Filed: Sep. 24, 2008

Related U.S. Application Data
(60) Provisional application No. 60/974,603, filed on Sep. 24, 2007.

(51) Int. Cl. G06F 9/44

(52) U.S. Cl. 717/109; 717/106

(57) ABSTRACT

An electronic clinical system receives protocol information from a clinical study or trial designer and automatically generates source code modules and a data model for a website used in conducting the study or trial. The source code modules are used in automatically generating and exposing case report forms for use by the clinical sites participating in the study.

### CROSS-REFERENCE TO RELATED APPLICATION

The present application is based on and claims the benefit of U.S. provisional patent application Ser. No. 60/974,603, filed Sep. 24, 2007, the content of which is hereby incorporated by reference in its entirety.

### BACKGROUND OF THE INVENTION

Before a pharmaceutical, biotech or medical device company can market a new experimental drug, molecule or device it must first be granted approval by the US Food and Drug Administration (FDA). Such approval is granted once the (FDA) is satisfied that the new experimental drug, molecule or device is both safe and effective for its intended use. This decision by the FDA to grant (or deny) such approval is done after reviewing clinical study data submitted by the pharmaceutical, biotech or medical device company (sponsor company). This clinical data is gathered in the process of conducting a clinical study (investigation). A clinical study is a systematic study designed to evaluate a product (drug, biologic or device) using human subjects, in the treatment, prevention, or diagnosis of a disease or condition, as determined by the product's benefits relative to its risks. Such clinical studies can only be conducted with the approval of the FDA. The FDA has published guidelines for the design and conduct of clinical studies and the sponsor company is responsible for compliance with them.

In order to minimize the likelihood of patient selection bias in a clinical study a geographically dispersed patient selection is desirable, therefore, almost always, multiple sites are recruited for participation in the clinical study (participating sites). Participating sites are then responsible for adherence to the FDA's guidelines for clinical study conduct known as Good Clinical Practice (GCP: an international ethical and scientific quality standard for designing, conducting, monitoring, recording, auditing, analyzing and reporting studies that insures that the data reported is credible and accurate and that subject's rights and confidentiality are protected).

There are several disciplines (roles) within both the sponsor company and the participating sites that are responsible for certain aspects of the clinical study. These disciplines or roles are referred to as study stakeholders, and include those listed below.

Study Administrators are usually employed by the sponsor and are (sometimes also known as a Clinical Research Associate (CRA)). Study administrators are responsible for monitoring a clinical study at all participating sites.

Study Monitors are usually employed by the sponsor and are responsible for determining that a study is being conducted in accordance with the study protocol, which is a detailed plan that sets forth the objectives, study design, and methodology for a clinical trial. A protocol describes what types of people may participate in the trial; the schedule of tests, procedures, medications, and dosages; and the length of the study. While in a clinical trial, participants following a protocol are seen regularly by the research staff and the participating sites to monitor their health and to determine the safety and effectiveness of their treatment. A monitor's duties may include, but are not limited to, helping to plan and initiate a study, and assessing the conduct of studies, ensuring that records and reports are performed as stated in the clinical protocol, standard operating procedures, GCP and by regulatory requirements.

Data Managers are usually employed by the sponsor and are responsible for reviewing the data gathered during a clinical trial. This review is intended to insure the consistency, sensibility and completeness of the data.

Biostatisticians are usually employed by the sponsor to analyze the data for statistical significance: the probability that an event or difference occurred by chance alone. In clinical trials, the level of statistical significance depends on the number of participants studied and the observations made, as well as the magnitude of differences observed.

A Data Safety and Monitoring Board (DSMB) is usually employed by the sponsor and is an independent committee, composed of community representatives and clinical research experts that reviews data while a clinical trial is in progress to ensure that participants are not exposed to undue risk. A DSMB may recommend that a trial be stopped if there are safety concerns or if the trial objectives have been achieved.

A Contract Research Organization (CRO) is a person or an organization (commercial, academic or other) contracted by the sponsor to perform one or more of a sponsor's study-related duties and functions.

Investigators are usually employed by the participating site and are medical professionals, usually physicians but may also be nurses, pharmacists or other health care professionals, under whose direction an investigational product is administered, dispensed or otherwise incorporated as part of patient care. A principal investigator is responsible for the overall conduct of the clinical trial at his/her site.

A Study Coordinator (also known as a Clinical Research Coordinator (CRC) or Research Coordinator) is usually employed by the participating site and acts as the site administrator for the clinical study. Duties are delegated by the investigator.

The terms “study” and “trial” will be referred to interchangeably herein. Therefore, when the term “clinical trial” is used, it will be understood that it also is intended to mean “clinical study” and vice-versa. When the term “clinical study” is used, it will be understood that it is also meant to include “clinical trial.”

The clinical testing of experimental drugs or biologics is normally done in four phases. Upon approval of a study sponsor's Investigational New Drug Application (IND) or in the case of a new molecular entity (biologic) their Biologic License Application (BLA), testing on human subjects can begin. Phase I studies are designed to establish the effects of a new drug in humans. These studies are usually conducted on small populations of healthy humans to specifically determine a drug's toxicity, absorption, distribution and metabolism. After the successful completion of phase I trials, phase II trials of a drug are used to test for safety and efficacy in a slightly larger population of individuals who are afflicted with the disease or condition for which the drug was developed. The third and last pre-approval phase of testing of a drug is conducted on large populations of afflicted patients. These phase III studies usually test the new drug in comparison with the standard therapy currently being used for the disease in question. The results of these trials usually provide the information that is included in a package insert and labeling and in their New Drug Approval (NDA) or in the case of a new molecular entity (biologic) their Biologic Device Approval (BDA).

After a drug or biologic has been approved by the FDA, phase IV studies are conducted to compare the drug or biologic to a competitor, explore additional patient populations, look for new indications or to further study any adverse events. Another type of phase IV study is called a postmarketing study commitment. Postmarketing study commitments are studies—required of or agreed to by a sponsor—that are conducted after the FDA has approved a product for marketing (e.g., studies requiring the sponsor to demonstrate clinical benefit of a product following accelerated approval). The FDA uses postmarketing study commitments to gather additional information about a product's safety, efficacy, or optimal use. Agreements with sponsors to conduct postmarketing studies can be reached either before or after the FDA has granted approval to a sponsor to market a product.

The clinical testing of experimental devices is conducted in a similar way. If the device is of significant risk to the patient (referred to as a Class III device), once the study sponsor has obtained approval of their investigational device exemption (IDE), they can begin testing on human subjects. Premarket approval (PMA) applications apply to any class III medical device. The PMA applies to all clinical investigations of devices to determine safety and effectiveness.

Upon approval of a NDA, BDA or PMA, the FDA may impose postapproval requirements in a post approval order or by regulation at the time of approval of the NDA, BDA or PMA or by regulation subsequent to approval. Postapproval requirements may include as a condition to approval of the drug, molecule or device, a continuing evaluation and periodic reporting on the safety, effectiveness, and reliability of the drug, molecule or device for its intended use (postapproval requirements).

Another type of study that is often undertaken by pharmaceutical, biotech and medical device companies are called postmarket registries which are more naturalistic, observational studies and less formal in terms of the strict adherence to GCP guidelines. Postmarket registries, unlike phase I-IV studies, are hypothesis generating studies as opposed to hypothesis driven studies.

Regardless of what type of study is being conducted (phase I-IV, as part of a NDA, BDA or PMA postapproval requirements, or a postmarket registry) the same study stakeholders (or a subset of them) are used for conducting and managing the study.

At any time during the progress of a clinical study any study stakeholder may require access to the collected data for their review. The specific data elements to be collected in support of the study protocol are defined in a series of Case Report Forms (CRFs). Data acquisition of clinical data using CRFs is an essential component for any study or trial. The clinical sites (such as hospitals, clinics or other facilities) that are participating in the study or trial fill out the CRFs with the data requested by those forms. The forms are then returned to the study sponsor or study administrator.

Returning completed CRF forms to the study sponsor or study administrator can be done by either physically sending them via fax or mail or by electronic transmission from a computer system. The physical transfer of CRF content via fax or mail is often referred to as a “paper-based system” Transmission of CRF content from a computer system, then, is referred to as a “computer-based system.”

In either system, CRF content must be reviewed for completeness, adequacy and validity to insure the integrity of the study. For instance, if a CRF asks for the consent date for a patient, and the date entered has not occurred yet, but is in fact a future date, then, in a paper-based system, the person reviewing the case report form will flag that form as containing invalid data, and it will be returned to the clinical site for correction or revision. In a computer-based system, entering the wrong consent date can be flagged with an online edit check (or validation) which results in an appropriate error message which can force the user to correct the data entry error at the time of actual online data entry. This is just one example of one type of edit check (or validation). There are many types of edit checks (or validations) that are used to increase the quality of the data at input time.

### SUMMARY

It can be seen that the collection of completed, clean and valid CRF data is important in maintaining the integrity of the study. It can also be seen that paper-based systems for data collection and review are cumbersome and error prone.

CRFs are made up of a collection of individual data elements (fields). Information describing each data element (field) such as Field Name, Type and Format is called metadata (data about data).

From time to time throughout the course of a clinical study the data is checked for consistency, accuracy and completeness by study administrators, study monitors or data managers. This task of checking the data for consistency, accuracy and completeness is part of a function called data management. For effective data management, the raw data and its associated metadata must be readily available to study administrators, study monitors, data managers and biostatisticians.

Also from time to time, and for the final clinical report, biostatisticians analyze the data and the study findings for statistical significance. For effective statistical analysis, the raw data and its associated metadata may desirably be readily available to biostatisticians.

As the various study stakeholders access the data from time to time it is highly advantageous that the data be in “real time,” (i.e., at the time of access, the data is current and up-to-date) and it is in a format that the particular study stakeholder is familiar with. Many of the study stakeholders use their own external applications to review the study data. For example, study administrators, study monitors and data managers use programs like certain spreadsheet applications, and biostatisticians use other types of statistical analysis programs. Therefore it may be desirable that an electronic system have the flexibility to output raw data in various output formats.

It can be seen that the availability of validated real-time data in the desired format can be highly beneficial, if not essential, for increasing the efficiency of conducting a clinical study and to its ultimate success.

In one embodiment, a clinical study designer can take clinical study descriptive information from a study protocol and other user requirement specifications and, by completing a number of data entry screens, can configure any number of internal functions to the requirements specified in the study protocol and the other user requirement specifications. The site generation system can then automatically generate source code output files and database tables that are used to create a customer website which is used in conducting the clinical study or trial.

In various embodiments, a clinical study designer may easily view, create and modify as needed case report forms and the characteristics of the individual data elements (fields) that comprise the case report forms (CRFs) such as data name, type and format (metadata). The clinical study designer can easily configure characteristics of these data elements (fields) to satisfy individual study needs. The CRF design criteria can be contained in the source code output files and database tables.

In some embodiments, a clinical study designer may easily view, create and modify as needed all inter- and intra-CRF edit checks (validations). The clinical study designer can easily configure characteristics of these edit checks to satisfy individual study needs. The edit checks (validations) design criteria can be contained in the source code output files and database tables.

In some embodiments, a clinical study designer may further easily view and modify as needed listing reports that are used to view the data by the various study stakeholders. The clinical study designer can easily configure characteristics of these reports to satisfy individual study needs. The listing report design criteria can be contained in the source code output files and database tables.

In some embodiments, a clinical study designer can also easily select any template from a standard template library for inclusion in the study design. The clinical study designer can easily configure characteristics of these templates to satisfy individual study needs. The template configuration criteria can be contained in the source code output files and database tables.

In yet another embodiment, the electronic clinical system provides for both raw data and metadata extraction of datasets in various formats as requested by a study stakeholder for use in other external applications.

### BRIEF DESCRIPTION OF THE DRAWINGS

FIG. 1 is a block diagram of one embodiment of a system for generating a website that is used for conducting a clinical study or trial.

FIG. 1A is a flow diagram illustrating overall creation and operation of the finished website shown in FIG. 1.

FIGS. 1B and 1C are screenshots further illustrating the creation of a study in accordance of one embodiment.

FIG. 1D shows an example of a case report form and validation of fields on the case report form in accordance with one embodiment.

FIG. 1E shows a relationship diagram.

FIG. 2 is a block diagram of a system, designed in accordance with FIG. 1, for acquiring or collecting clinical data.

FIG. 3 is a block diagram of one embodiment of a system illustrating how datasets are made available in real time to the various study stakeholders in virtually any desired format.

FIG. 3A is a flow diagram illustrating one embodiment of the overall operation of the system shown in FIG. 3.

FIGS. 3B-3H are screenshots illustrating some examples of how datasets are made available in real time to the various Study stakeholders in virtually any desired format.

FIG. 4 is a more detailed block diagram of the system shown in FIG. 1 showing website generation functionality.

### DETAILED DESCRIPTION OF ILLUSTRATIVE EMBODIMENTS

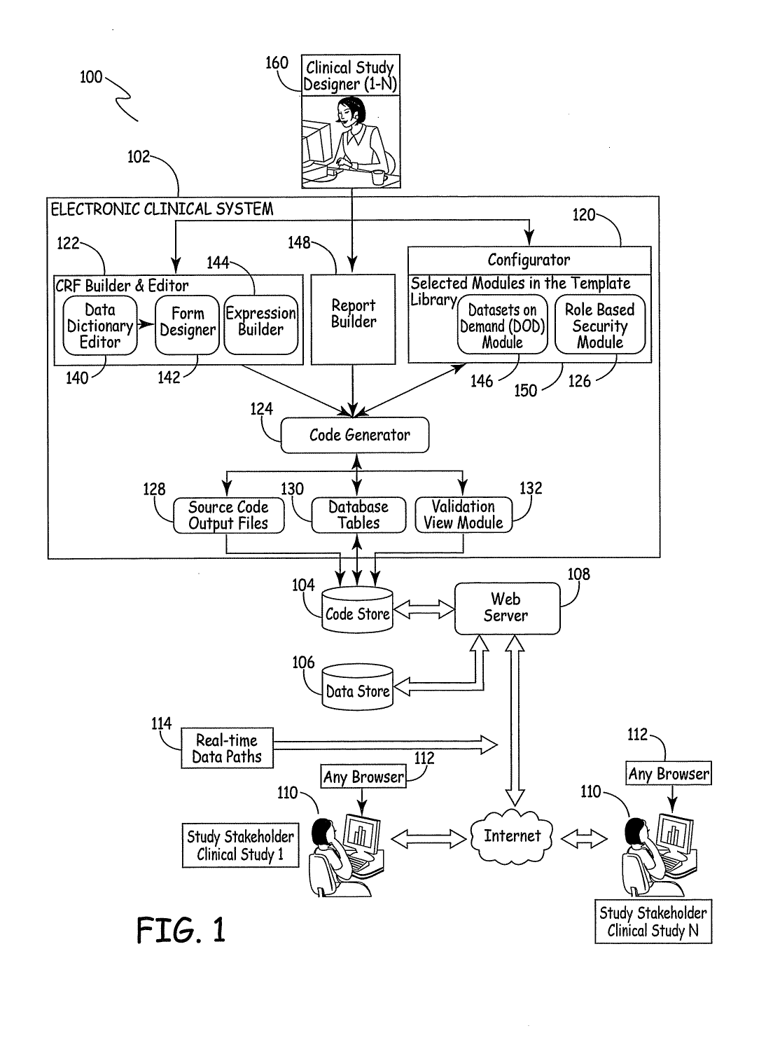

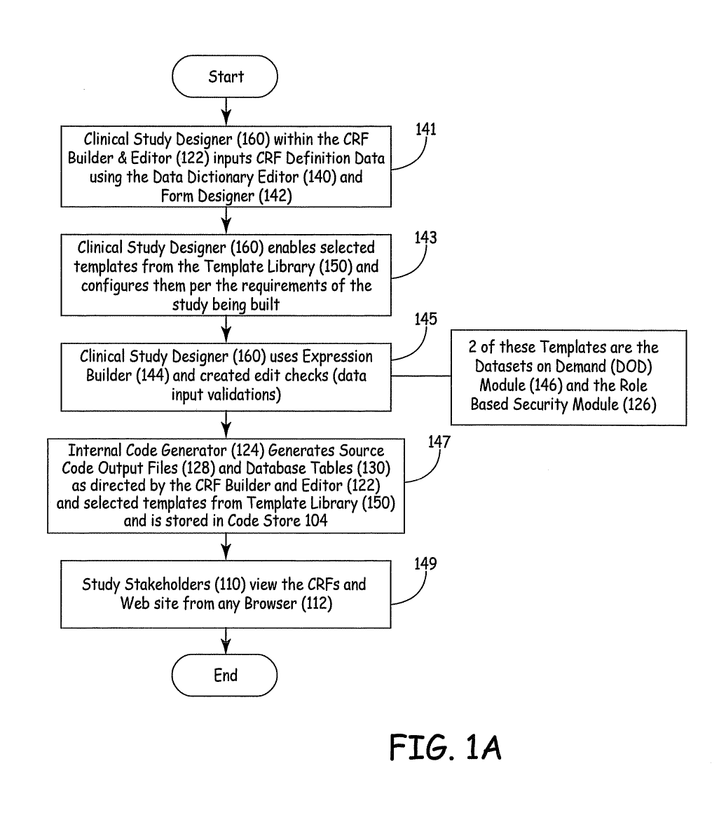

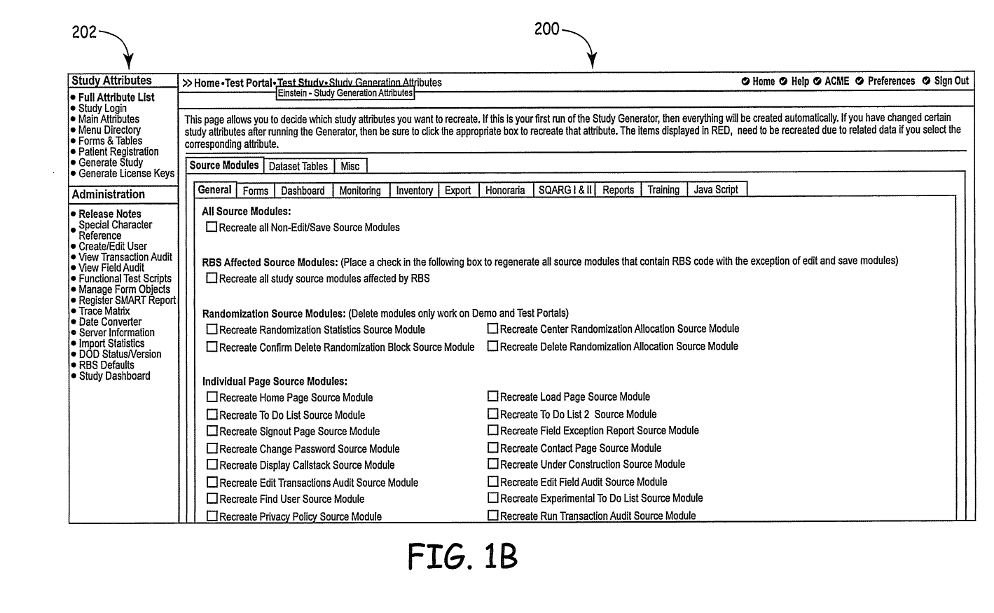

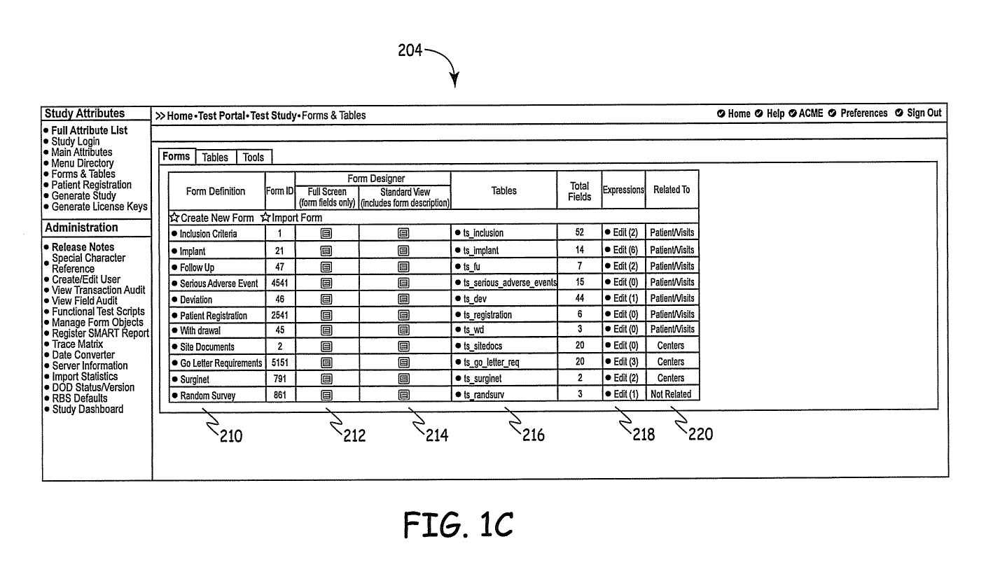

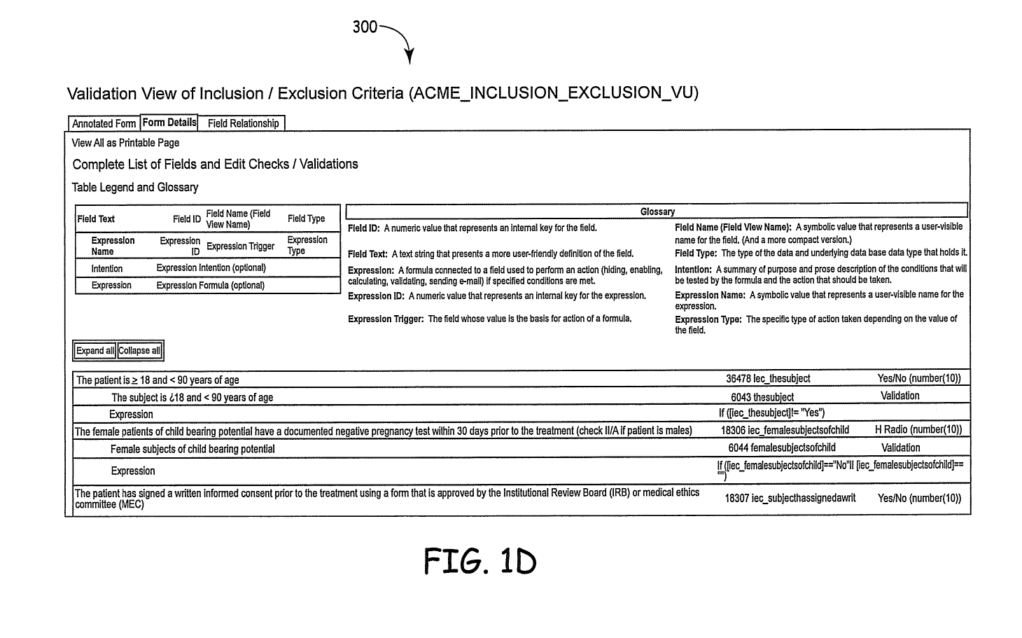

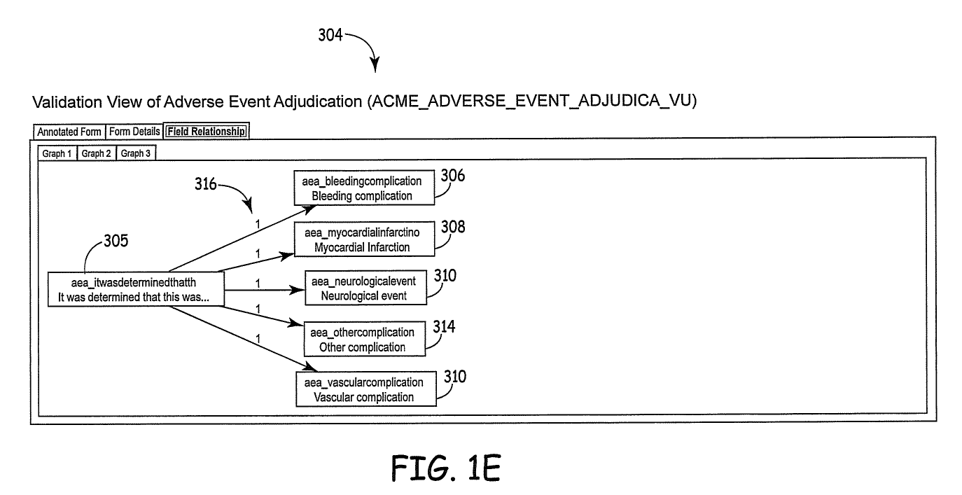

FIG. 1 is a block diagram of a system 100 for designing a website for conducting a clinical study or trial. System 100 includes electronic clinical system 102, code store 104, data store 106, Web server 108 that services a plurality of study websites 110 (each of which has a browser 112) and real-time data path 114. A brief description of each of these blocks and an overview of certain data flow paths is first described.

Electronic clinical system 102 illustratively includes CRF builder and editor 122, that itself includes data dictionary editor 140, form designer 142 and expression builder 144. System 102 also includes modules contained in a template library 150 within a configurator 120, including datasets on demand module 146 and role based security module 126. System 102 further includes code generator 124, source code output files 128, database tables 130 and validation view module 132. System 102 also illustratively includes report builder 148.

Clinical study designer 160 interfaces to electronic clinical system 102 through the CRF builder and editor 122 and configurator 120, which is used to configure selected templates from the template library 150. A number of illustrative templates are discussed in greater detail below.

Configurator 120 provides a number of data entry screens that enables clinical study designer 160 to select various options and characteristics for a number of internal functions, including illustratively, those in CRF builder and editor 122, (data dictionary editor 140, form designer 142 and expression builder 144) and the modules contained in the template library 150 (including data sets on demand module 146 and role based security module 126).

Data dictionary editor 140 is used to import a data dictionary that is illustratively in a spreadsheet format (such as Excel by Microsoft Corporation) and case report forms (CRFs) are automatically created after a successful import. Form designer 142 is used to create, layout, edit and format CRFs. Expression builder 144 is used to create and edit the edit checks (validations) that can be associated with each data element (field) in each CRF.

Case report form design information from the form designer 142 and expression builder 144 is sent to the code generator 124 and source code output files 128 and database tables 130 are created and stored in the code store 104. Code store 104 thus stores design information for each CRF for each study (website) that was inputted by the clinical study designer 160.

Individual datasets taken from the CRFs can be created by a computer programmer within the datasets on demand (DOD) module 146. Clinical study designer 160 configures field types, labels, formats and other metadata within datasets on demand (DOD) module 146. Dataset design and configuration information is sent to the code generator 124 and the corresponding source code output files 128 and database tables 130 are created and stored in the code store 104.

Validation view module 132 provides means for a study stakeholder to view an annotated CRF (a CRF which has actual database field names shown next to the field text as it appears on the CRF) and descriptions of edit checks that are associated with the data elements (fields) on the CRF.

Clinical study designer 160 creates and edits online listing reports using report builder 148. Individual report design information using report builder 148 is fed to the code generator 124 that generates source code output files 128 and database tables 130 and stores them in the code store 104.

Clinical study designer 160 selects from a list of standard templates that are to be included in the study currently being built using configurator 120. Configuration information on selected templates is fed to the code generator 124 and corresponding source code output files 128 and database tables 130 are created and stored in the code store 104.

In the role based security module 126 the clinical study designer 160 identifies all the pages or groups of like pages that exist in the website. The clinical study designer 160 then assigns page access rights to different roles (study stakeholders) in the system. Rights are used to grant or deny the user access to the page or page groups. A robust set of defaults can be defined. Information on role based security setup is stored in code store 104. This is described in greater detail below.

Web server 108 serves up web pages on demand from any number of study stakeholders from any number of sites 110 from any number of separate studies currently taking place at sites 110. In one embodiment, each separate study has its own unique website (unique domain names in URL—web site address).

A study stakeholder at sites 110 inputs patient data into the CRFs as displayed via any browser 112. Patient data is stored in data store 106. Patient data is retrieved for viewing or editing via real-time data path 114.

FIG. 1A is a flow diagram illustrating a high level view of the overall operation of system 100 shown in FIG. 1. First, clinical study designer 160 inputs CRF definition data using data dictionary editor 140 and form designer 142. This is indicated by block 141. The clinical study designer then enables selected templates and configures them, as specified by a set of user requirement specifications, through CRF builder and editor 122. This is indicated by block 143. The designer then uses expression builder 144 to create edit checks, as indicated by block 145.

The internal code generator 124 then generates the source code output files 128 and database tables 130 as directed by the CFR builder and editor 122 and the selected templates, as indicated by block 147. The source code output files 128 and database tables 130 taken together comprise the website design front end (CRFs) and the backend database that is linked to the CRFs to implement a study at a site. They are stored in store 104. Study stakeholders at any site 110 can view the CRFs and website from any browser 112. This is indicated by block 149.

FIG. 1B is one illustrative embodiment of a user interface display 200 showing how a website is initially generated and how it is regenerated when it is desirable to incorporate recent changes that have been made to non-shared code files or templates.

In the embodiment shown in FIG. 1B, the interface 200 allows the user to choose a plurality of different modules to be updated for this study. Some illustrative attributes are listed in a column 202 on the left side of the user interface 200 shown in FIG. 1B. Of course, additional or different attributes can be used as well. FIG. 1B shows general attributes or modules which can be selected (by checking a box) for generation or regeneration.

FIG. 1C illustrates another exemplary user interface 204 when the user chooses the “Forms” attributes in FIG. 1B. The interface shown in FIG. 1C allows the user to create a new form, import an existing form or edit an existing form.

When the user selects “Create New Form” or one of the Forms listed, component 122 (shown in FIG. 1) displays further selectable features, which can be selected by the study designer, for inclusion in the selected case report form. Component 124 then saves the configuration for the various case report forms input by the user, and generates the source code modules 128 for displaying in a browser. Also, component 124 generates the database tables 130 which show how the various case report forms are related to one another.

The interface shown in FIG. 1C also includes options which allow a user to view a full screen version (fields only) of the fields in each of the preexisting forms, or to see a standard view (fields plus all descriptive text). Similarly, the user interface identifies the tables in database 106 where the data for the forms is stored. The preexisting forms are selectable from column 210 and the view of the forms is selectable from columns 212 and 214. The tables which the forms are comprised of are identified in column 216.

The interface shown in FIG. 1C also includes a column 218 which leads to a list of expressions which are formulas used to create edit checks (validations) for the fields on the form. Column 220 indicates what each form is related to (such as a patient, a visit, or a study site or center).

Once all of the forms have been created and formatted, component 124 generates the source code output files 128 and database tables 130 and this CRF design information is stored in component 104.

FIG. 1D shows the validation view 300 of a sample form. A validation view 300 shows a complete list of all fields in the form plus all edit checks (validations) associated with each field. In this expanded view the details of an expression are shown. In the first example, the expression is verifying that the patient is between the ages of 18 and 90. If not, this expression will trigger a block which will prevent this patient from being enrolled in the study.

FIG. 1E shows an illustrative user interface 304 that shows the dependencies of fields within a form (Field Relationships). This example shows that an adverse event 305 can be caused by a bleeding complication 306, a myocardial infarction 308, a neurological event 310, a vascular complication 312, or something other 314. This relationship diagram is the direct result of writing an auto-fill type edit check that specifies if either one of these five conditions occurs, then an adverse event has also occurred. The direction of the arrows shown in FIG. 1E indicates a parent-child relationship and in this example, the adverse event field 305 is dependent on these five other fields.

In another embodiment, when the user is viewing the display shown in FIG. 1E, and the user hovers over and clicks on the number 316 on the arrow connecting the two fields, the full validation name, type and description is displayed.

The graphical relationship of the fields in a given form can be very helpful. For instance, if a user or study designer wishes to make a change to a form, it may be helpful for the study designer to be able to quickly and easily see what other fields will be affected if one field is changed. This can be done very efficiently using the graphical illustrations shown in FIG. 1E.

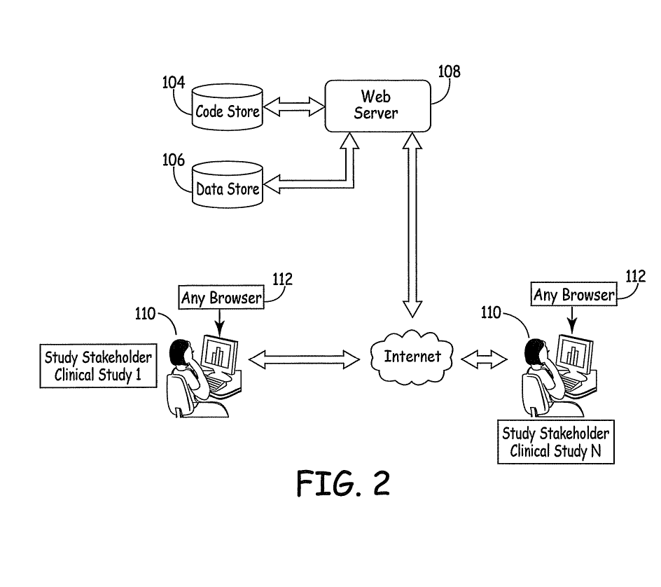

FIG. 2 is a block diagram of system 100 in which a study stakeholder at a study site 110 is entering patent or study data into the case report forms. The system shown in FIG. 2 has a number of similar items to those shown in FIG. 1 and they are similarly numbered.

A study stakeholder 110 is served webpages by web server 108 from CRF composition data stored in code store 104. Study stakeholder 110 inputs data into CRFs which is stored in data store 106. A Study stakeholder's 110 access to the website may first be granted by unique ID and password login.

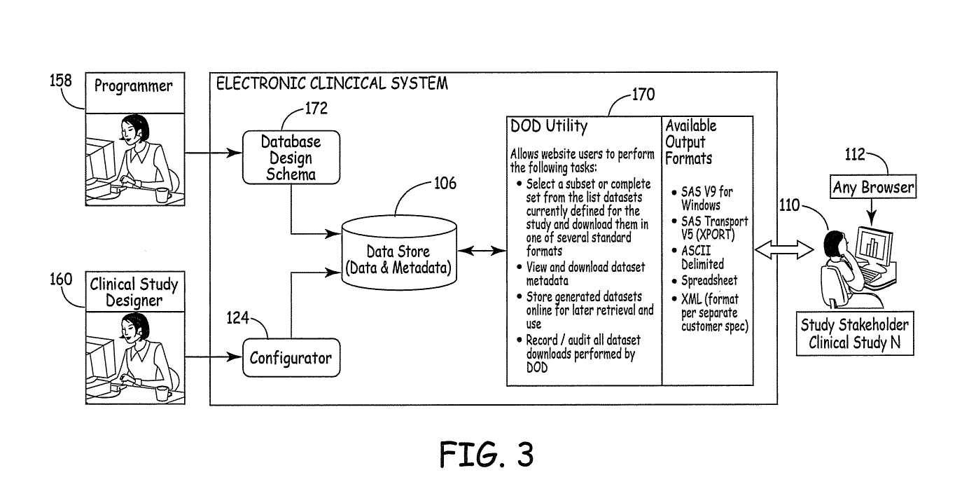

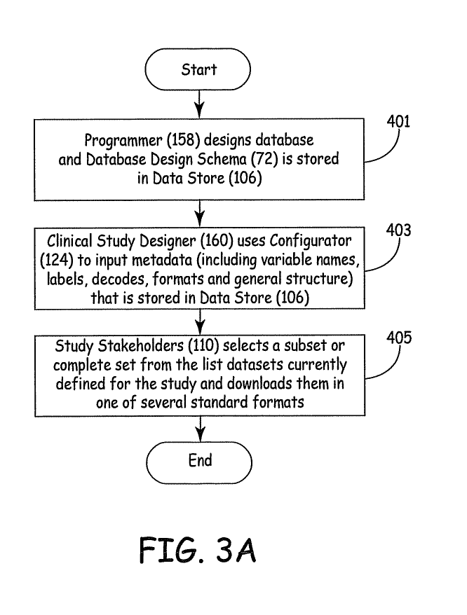

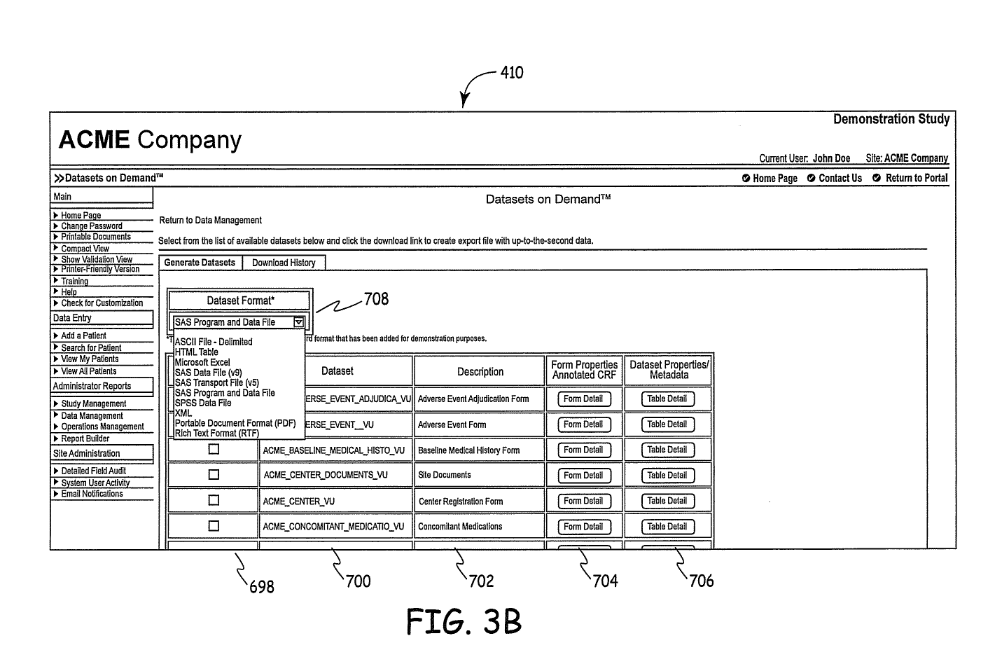

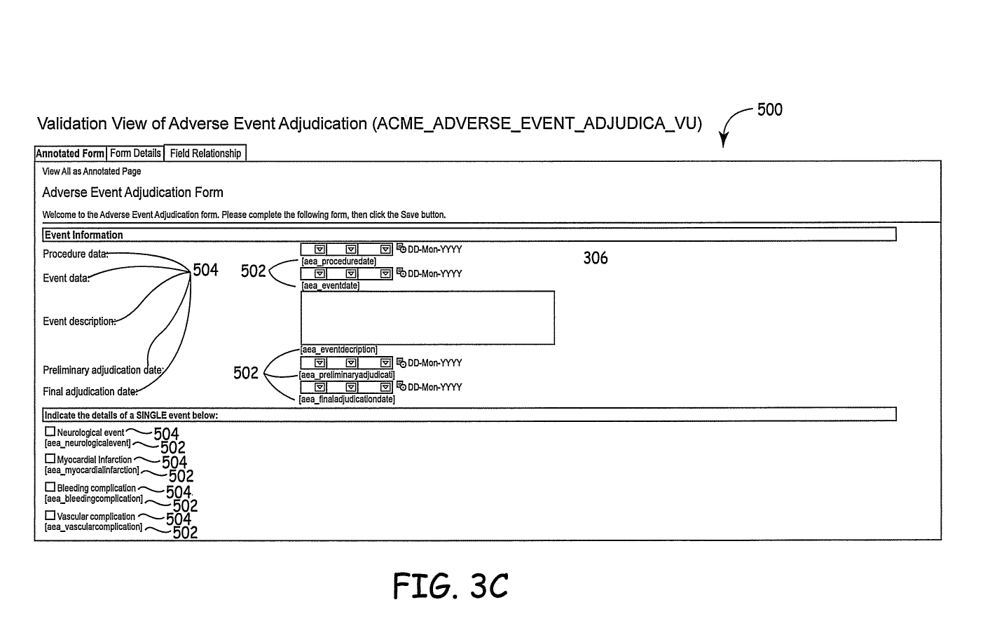

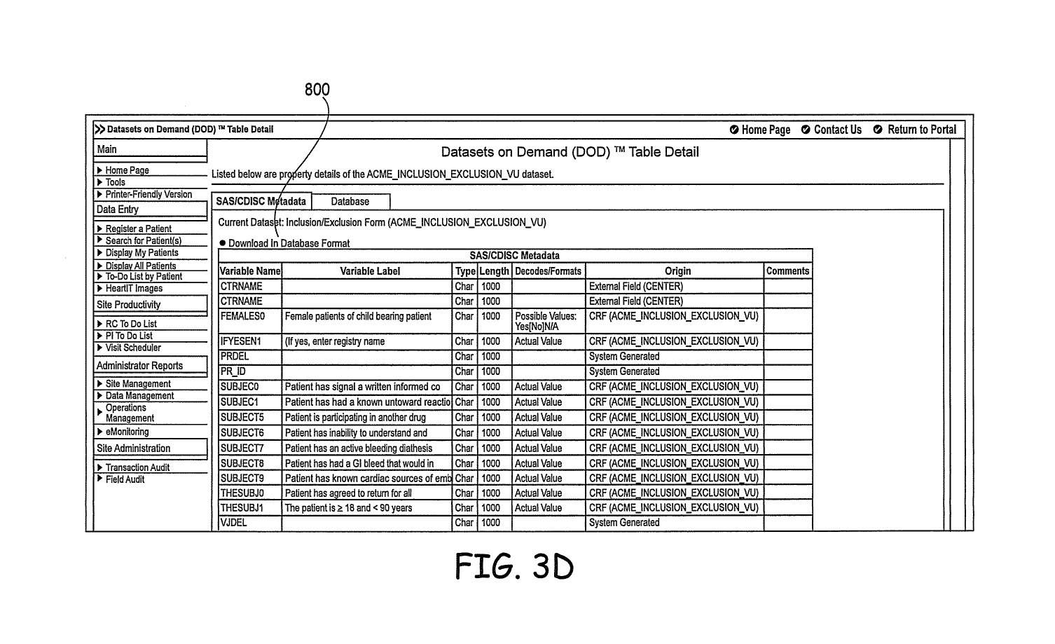

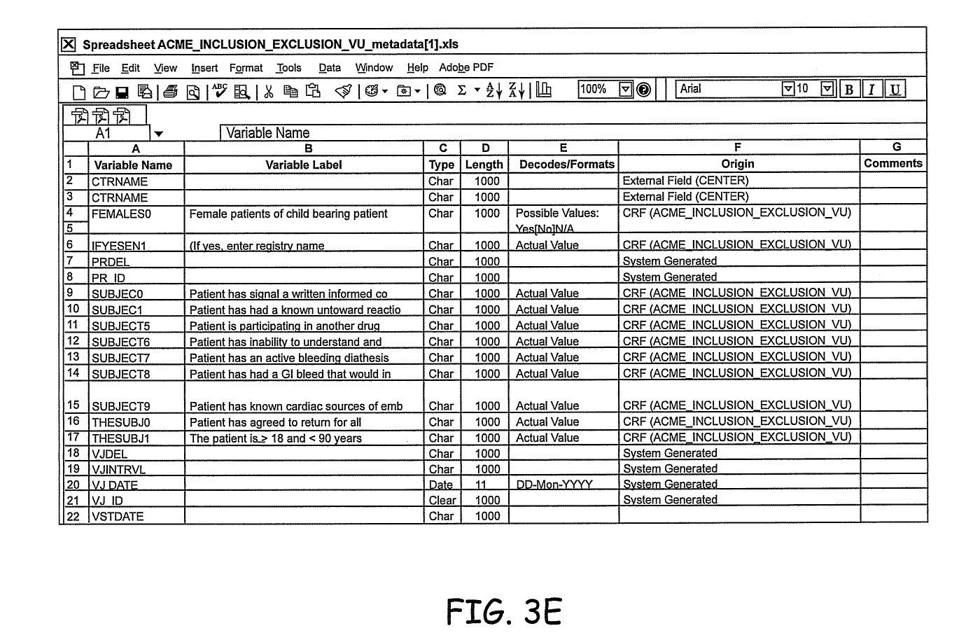

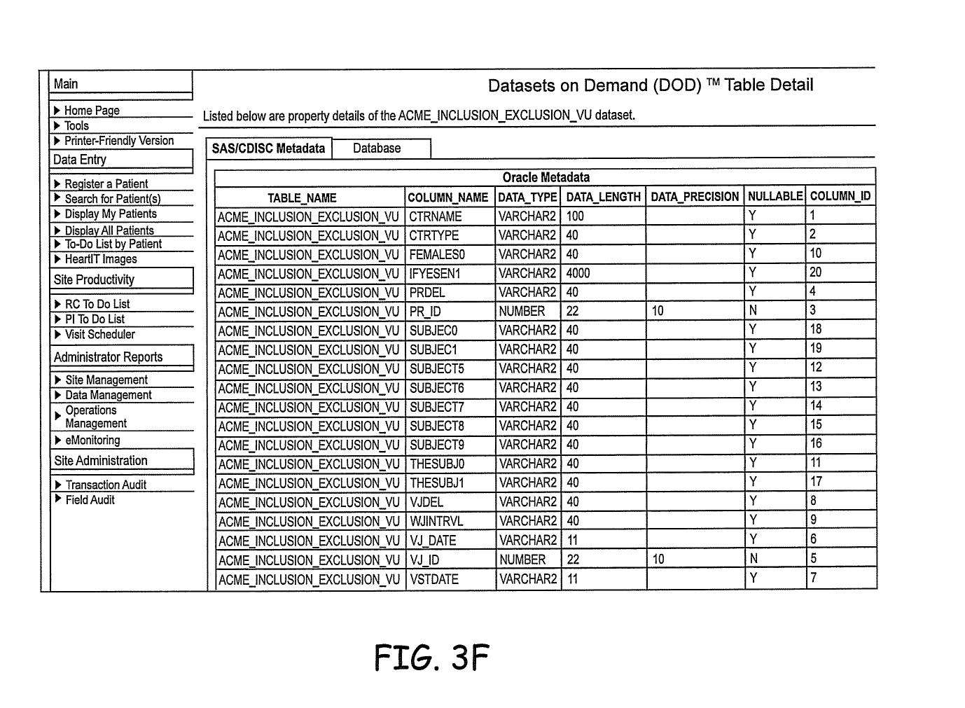

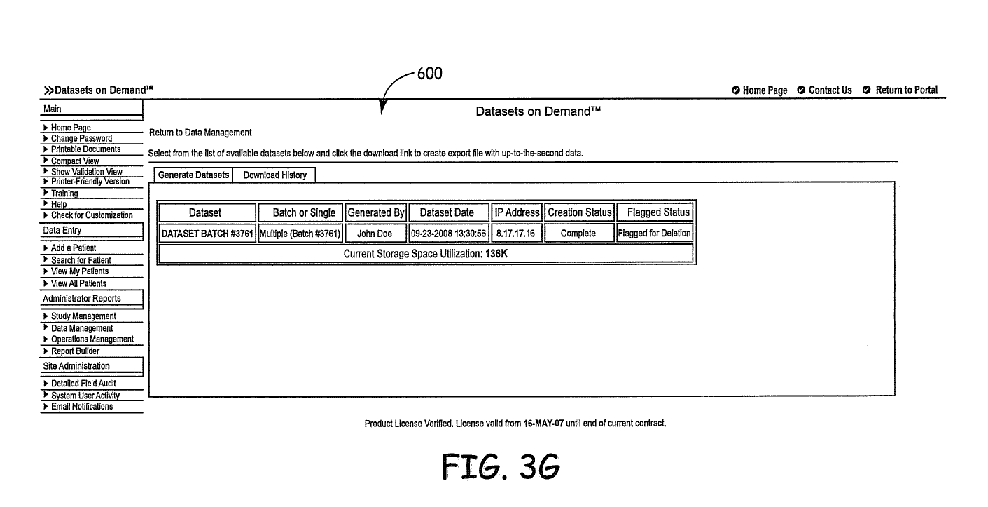

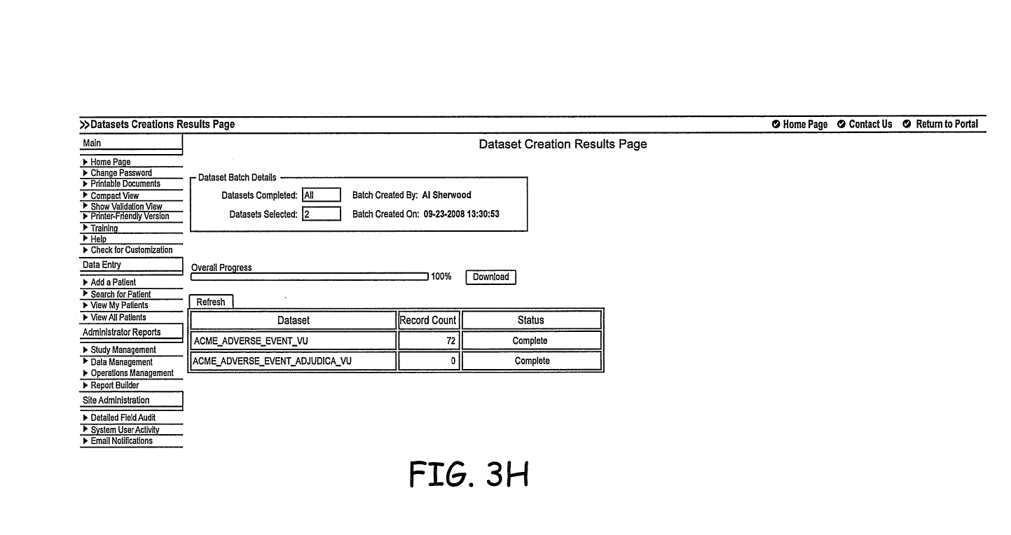

FIG. 3 is a block diagram illustrating one embodiment of how the system makes datasets (an output of data values from the electronic clinical system 102) available to study stakeholders on demand, in real time and in virtually any desired format. In one embodiment, the most common individual dataset is a listing of all the fields belonging to a single case report form. All standard datasets also illustratively include one or more system-generated variables/columns that are used to relate one dataset to another, and to uniquely identify records and values (PKs and FKs). Datasets delivered by DOD module 146 (shown in FIG. 1) are queried/returned in real-time, meaning the data is current up to the time that the download button is clicked.

A number of the items in FIG. 3 are similar to those shown in the previous figures and are similarly numbered. FIG. 3 also, however, includes system design scheme 172 input by a programmer 158, and a list of utilities and output formats 170 available through store 106 (based on the configuration by DOD module 146).

FIG. 3A is a flow diagram illustrating one embodiment of the overall operation of the system shown in FIG. 3 in more detail.

Programmer 158 designs a database and the associated database design schema 172, which defines the database design, is stored in data store 106. This is indicated by block 401. Clinical study designer 160 uses configurator 124 to input metadata (including variable names, labels, decodes, formats and general structure) that is stored in data store 106. This is indicated by block 403. The DOD utility 170 provided by the DOD module 146 part of electronic clinical system 102 shown in FIG. 1 allows study stakeholder 110 to select a subset or complete set from the listed datasets currently defined for the study and to download them in one of several standard formats, view and download dataset metadata, store generated datasets online for later retrieval and use and record/audit all dataset downloads performed by DOD module utility 170. DOD utility 170 provides on demand access to customer data in a variety of file formats delivered as individual datasets.

FIG. 3B shows an embodiment of a display 410 that allows a stakeholder to select datasets for download. This list in FIG. 3B is illustratively scrollable so more entires in the list can be viewed. In the embodiment shown in FIG. 3B, the datasets shown in column 700 can be selected for downloading to the study stakeholder 110. This is indicated by block 405 in FIG. 3A. A description of each of the datasets is indicated in column 702, and details associated with the forms and tables of the dataset can be obtained by actuating buttons in column 704 and 706, respectively. The desired format for download of the dataset or datasets can be selected in drop-down box 708. Once all of the desired selections are made by checking boxes in the first column 698, study stakeholder 110 can initiate the download process by actuating, for instance, a button at the bottom of the page.

In the embodiment shown in FIG. 3C, an annotated CRF 500 is shown the actual database field (variable) names 502 are shown next to the text label 504 on the CRF. Having the capability to see these two juxtaposed can be important for those study stakeholders 110 who use external programmable applications such as Statistical Analysis Software (SAS). A biostatistician using a statistical analysis package such as SAS needs to have confidence that the variable names match up with the CRF text labels when they are writing programs in SAS or when they are looking to verify that an existing program will work correctly. Thus, the view in FIG. 3C presents advantageous.

FIG. 3D illustrates table detail, including metadata, in a SAS/CDISC format for the first dataset “ACME_inclusion_exclusion_VU” dataset shown in FIG. 1D (which can be selected from the list shown in FIG. 3B). The table detail for the selected dataset includes variable names for variables in the table, labels for those variables, the type, length and decoder formats for each of the variables, as well as comments. In addition, the origin for data in each of the variable fields is indicated as well. The origin indicates where data that was entered in the given field originates from. It can be seen at 800 in FIG. 3D that the details can be downloaded in a spreadsheet format or some other type of format as well.

FIG. 3E shows one example of the same information shown in FIG. 3D, except after it has undergone a format conversion into the format used by Excel spreadsheets.

FIG. 3F shows a sample of additional metadata for the dataset selected from the list in FIG. 3B. This set of metadata (which happens to be, by way of example, Oracle database metadata) lists the Table Name, Column Name, Data Type, Data Length and Precision (for numerical data types) whether the data is nullable (can be blank), and the Column ID.

In one other embodiment shown in FIG. 3G, the datasets on demand utility 170 in FIG. 3 also tracks the download history for each dataset. This can be viewed by the study stakeholders 110 as shown in display 600 shown in FIG. 3G.

The download history illustratively identifies the dataset (with a click-thru to that dataset), whether it was part of a batch or a single dataset, the person that generated the dataset (or downloaded it), the date that the dataset was downloaded, the Internet Protocol (IP) address it was downloaded to, the creation status and the archive status. Download history can be important, especially when trying to troubleshoot problems with datasets.

In one other embodiment shown in FIG. 3H, the datasets on demand utility 170 shown in FIG. 3 also provides a completion status for each download, including dataset name, record count and status.

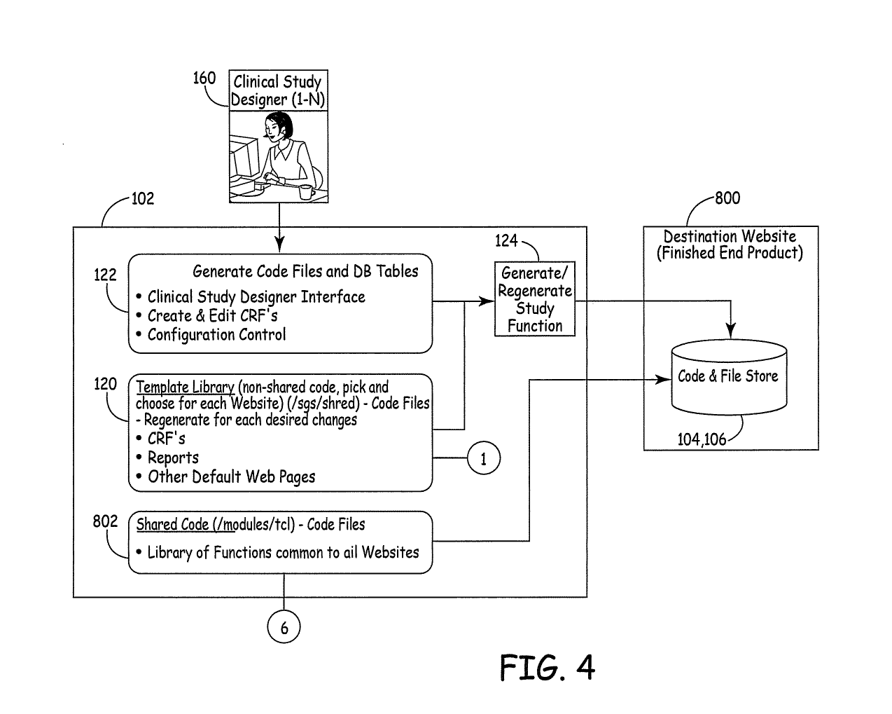

FIG. 4 illustrates, in more detail, a portion of system 102 and how a complete website solution can be built without writing a single line of code. The general methodology is that it “creates websites.” FIG. 4 shows that the CRF builder and editor 122 supports an interface that allows a clinical study designer 160 to make selections to create and edit CRFs and configure controls. Components 120 and 122 expose code that the clinical study designer 160 sees when they log into system 102 (i.e., CRF Builder and Editor, Expression (Edit Check) Builder and Editor, Check boxes and drop-down menus for configuring the design and function of the Website). The designer 160 thus makes the necessary selections from the set of displayed screens to create settings used to define the Website solution.

Each template in the Template Library 120 is a file which, when selected for the Website solution 803 being designed, is copied into the destination website 803 during the code regeneration process, implemented by code generator 124.

A template is any function or feature that has become a website design standard that can be added to a study or updated using only the study generation process, requiring no additional coding.

Shared code 802 is common to all websites generated by system 102 and implements certain functionality used by all websites. It is this combination of settings used by components 120 and 122, selected, templates 120, and shared code 802 that produces a complete destination website 803 stored in code store 104 and data store 106.

A brief discussion of some Templates that may be used in the system is now provided. Study stakeholders have their own individual responsibilities (or functions) for insuring the overall success of a clinical study. Fulfillment of these responsibilities (functions) is aided by the availability of certain standard templates that may comprises the template library 150. Such templates can include, by way of example only, the following:
1. Datasets on Demand (DOD)—provides the real-time data (raw data extracts of datasets);
2. Various online reports which allow study stakeholders to view data appropriate to their responsibility; and
3. Various workflow assistance functions which help study stakeholders queue up their workload appropriate to their responsibility

Each template in the template library 150 has one or more associated webpages used for real-time data presentation, reporting, providing workflow assistance prompts or a combination of these, and each template provides a unique function. One exemplary list of templates, and a brief description, is set forth below in Table 1. It will be noted that where the template name is sufficiently described, no additional description is provided.

TABLE 1
List of Templates:

| | | |
|---|---|---|
| 1. | AutoHonoraria | Initiate payments due |
| | | Edit amounts by site by interval |
| | | Complete history of payment activity by site |
| | | Complete history of all Honoraria runs |
| | | Generates Honoraria detail letters listing investigator |
| | | reimbursable activities |
| | | Direct individual patient record link for quick, easy site |
| | | payment query resolution |
| 2. | Change Password | |
| 3 | Create/Edit Center | |
| 4. | Create/Edit User | |
| 5. | Datasets on Demand | Allows authorized individuals to download different |
| | (DOD) | datasets used for analysis. Formats include SAS |
| | | Datasets (v9), SAS Transport (v5), MS Excel and ASCII |
| 6. | Email Notification | |
| 7. | EMonitoring | Supports the highly efficient identification, communication and |
| | | resolution of data queries |
| | | Includes complete query dialogue tails and in-depth reporting |
| 8. | Form Change Log | |
| 9. | Global Messaging | Message, Start Date, Stop Date, Study, Audience, Status |
| 10. | Inactivation Request | |
| 11. | IRB Management System | Automatically communicates upcoming renewal dates to sites via |
| | | email and/or fax |
| | | Messages highly user-configurable and automatically personalized |
| | | to recipient |
| | | Can optionally suspend enrollment privileges for non-compliant |
| | | sites |
| | | Complete reports and audit trails detail all messages sent and sites' |
| | | responses |
| 12. | Medications | |
| 13. | Password Expiration Page | |
| 14. | Patient Record Page | |
| 15. | Printable Documents | |
| 16. | Randomization | |
| 17. | Report: Adverse Event | A listing and complete description of each reported |
| | (AE)/Serious Adverse | Adverse Event, including: Status, Interval, Treatment |
| | Event (SAE) | Date, MedDRA Code, whether it was a Serious Adverse |
| | | Event (SAE), Onset Date, Resolution Date, Outcome |
| | | and Drug Relationship |
| 18. | Report: Dashboard | From a single screen, a Study Manager or CRA can view all details |
| | | of a Site's activity |
| | | Various Site level Reports are available |
| | | Participant details can be directly accessed by selecting the name - |
| | | contact details can be edited, emails/letters sent, etc. |
| 19. | Report: Display All Patients | |
| 20. | Report: Display My Patients | |
| 21. | Report: Field Audit | |
| 22. | Report: IP Activity | |
| 23. | Report: Missing Data Form | |
| 24. | Report: Outlier | List of fields where the value entered is outside of specified normal |
| | | range - available for management review |
| | | Full filtering and drill-down capability with user-specific |
| | | messaging |
| 25. | Report: Protocol | A listing and complete description of each reported |
| | Deviations | Protocol Deviation, including: Interval, Patient ID, Site |
| | | Name, Source CRF, Deviation Description, Deviation |
| | | Code, Date of Deviation and current Status |
| 26. | Report: RC To Do List | Admin only view of each Site's RC To Do List |
| | | See at a glance the number of To Do List Items at each Site |
| | | Identify sites that are having “trouble” early, before it's too late |
| 27. | Report: Site Data Collection | Shows a running total of completed and missing data |
| | Progress | A multi-colored visual of patient progress through the study |
| | | protocol by Site |
| 28. | Report: Site Ranking | |
| 29. | Report: Site Start-up Progress | Global site readiness progress at a glance - highlighting specifics to |
| | | focus activities |
| | | Auto-populates from Site Documents |
| | | Click on Site name to add/edit |
| | | Exports to Excel |
| | | Emails to user-specified individuals by button press or |
| | | automatically at specified frequency |
| 30. | Report: Transaction Audit | |
| 31. | Report: Unlocked Forms | Monitor data revisions and record unlocking, Full audit |
| | | trail generation |
| 32. | Report: Unlocked Records | |
| 33. | Report: Unscheduled Events | Tally of global events such as: Protocol Deviations, AEs/SAEs and |
| | Tally | Withdrawals by interval |
| | | Incorporates hyperlinks to reports in each category for further |
| | | analysis |
| 34. | Report: Visit Schedule | Automatically generated by study activity |
| | | Assists sites in scheduling visits within required windows and in |
| | | workflow planning |
| | | Automatically updates as individual visits are completed |
| 35. | Report: Website Activity | |
| 36. | Role-Based Security (RBS) | |
| 37. | Search For Patient | |
| 38. | Search For User | |
| 39. | Sign On | |
| 40. | Site Documents | Individual site-level management of Sponsor specified |
| | | study related documents |
| | | “Approved to Enroll” strictly enforced |

In another embodiment of the system shown in FIG. 1, role based security (RBS) can be used and implemented using module 126. RBS allows study designers to determine exactly which pages a particular user at a site 110 can access. One way to implement RBS is by defining pages in a way to implement RBS. There are many ways to do this and the system 102 reports which pages are accessible in a variety of ways. Either a user has access to a page or the user does not. If not, the page will not show up as a link or menu option for that user. If the user has access, it will. RBS can be thought of in terms of whether a designer wants to allow access to a certain page.

In one embodiment, RBS is comprised of three different levels:

### 1. Pages and Form Templates;

### 2. Rights; and

### 3. Roles

A designer 160 can define pages and form templates through module 126 to generate a RBS model that implements RBS. Pages and form templates are the lowest item on the RBS model. Pages can pertain to either the portal or study. Pages can be defined in one of three different ways:

1. Individual pages
2. Batches of like pages
3. Form Template page relationships (Constants)

Individual pages are the simplest items to define. However they are not very efficient and therefore may desirably be used as little as possible. The user defines a single page source module that defines who has access to a given page. Pages are referred to and referenced by their source module name.

Similar to individual pages, batches of pages can also be defined. Batches of pages can be grouped into batches based on functionally (such as eMonitoring Pages or Main Menu Pages). They can be defined in a batch and then assigned by a right as a single entity. This is much more efficient than defining a single page.

In one embodiment, the designer can define form templates also known as edit and save modules. System 102 can allow the user to define a large variety of web forms. The user enters information that the system captures and stores in the database. These forms contain two source modules, EDIT and SAVE. The user can define different types of form templates in RBS and group them simply by identifying common form attributes such as Visit Related Forms or Site Document Forms.

Rights allow the user to take the Page and form template definitions and place them into a right. A right is comprised of a Page or Form Template definition. Rights will be used to grant or deny the user access to the page or pages that make up a right. Once pages are defined as either batches or form templates they need to become rights so that they can be placed into roles.

The top level of the RBS data model is a role. A role is a group of a variety of things. First roles can contain rights. These rights can be granted or denied to a particular role. Roles can also inherit other roles. This makes RBS extremely flexible. Because many different user types are very similar but not identical, roles can be inherited, then additional pages can either have access granted or denied. An example might be a that designer 160 has access to everything. A super administrator has access to everything except a handful of delete modules. To create a super administrator role the user may want to grant the developer role and then define a batch of the delete pages that are not accessible to a super administrator. Next the user creates a right for that batch of pages and denies that right to the super administrator. Using this method the user can give a super administrator access to exactly the pages the user wants (perhaps hundreds of them) in 2 easy steps.

It can thus be seen that the present system provides an efficient mechanism for generating a study or trial, for entering data during the study or trial, for setting up and viewing validations for the data, and for downloading real time data. Of course, the invention is not limited to including all of these features, and each one comprises a substantial improvement, in and of itself.

Although the present invention has been described with reference to preferred embodiments, workers skilled in the art will recognize that changes may be made in form and detail without departing from the spirit and scope of the invention.

What is claimed is:

1. An electronic clinical system, comprising:
a code generator component receiving definition data indicative of designer selections of options provided on a plurality of user interface screens for defining a study, and generating a plurality of source code output files and database tables, that comprise website solution that implements the study and renders case report forms for data acquisitions;
a database configured to store the source code output files and the database tables for the study and for storing data acquired through completing of the case report forms; and
a server configured to serve web pages that run the study.

2. The electronic clinical system of claim 1 wherein the code generator component is configured to expose an interface that displays the user interface screens and to receive study attribute data through the interface exposed and to generate the source code output files that contain the study attributes.

3. The electronic clinical system of claim 1 wherein the code generator component is configured to generate separate source code output files and separate database tables for each separate study.

4. The electronic clinical system of claim 3 wherein the code generator component and the web server are integrated into a single system.

5. The electronic clinical system of claim 1 wherein source code output files and database tables are configured to render case report forms over a wide area network.

6. The electronic clinical system of claim 5 wherein the code generator component is configured to receive validation information that defines validations for data fields in the case report forms.

7. The electronic clinical system of claim 6 wherein the source code output files and database tables are configured to execute the validations once data is acquired.

8. The electronic clinical system of claim 1 wherein the data model includes metadata defining the case report forms and the relationships between the case report forms.

9. The electronic clinical system of claim 8 wherein the code generator component is configured to generate a relationship display graphically displaying the relationships and dependencies between fields on a case report form.

10. A method of generating a website for purposes of conducting a clinical study or trial, comprising:
exposing a study definition interface, over a wide area network, for receiving case report form definition data defining case reports for use in acquiring clinical data in the study;
generating source code output files and database tables for rendering each case report form defined by the case report definition data; and
generating a data model for each unique study that defines the relationships between the case report forms.

11. The method of claim 10 wherein exposing a study definition interface comprises:
exposing an interface to receive user defined validations for fields in a case report form.

12. The method of claim 11 wherein generating source code output files comprises:
generating the source code output files to execute the validations after data is acquired.

13. The method of claim 10 wherein exposing a study definition interface comprises:
automatically generating metadata describing fields in the case report forms based on the case report form definition data.

14. The method of claim 10 and further comprising:
generating a graphical display of field relationships within a case report form.

15. The method of claim 10 and further comprising:
using the source code output files to generate a data acquisition interface in a form defined by the case report forms definition data.

16. The method of claim 15 and further comprising:
receiving clinical data required by the study through the data acquisition interface; and
storing the clinical data along with the metadata defining the case report forms used to generate the data acquisition interface.

17. The method of claim 16 and further comprising:
receiving a request for the clinical data; and
automatically generating one or more clinical datasets and associated metadata download in real-time.

18. The method of claim 17 and further comprising:
receiving a dataset(s) output format request defining a requested output format in which the clinical data and associated metadata is to be outputted, and automatically providing the one or more datasets in the requested output format.

19. The method of claim 18 where after receiving a dataset output format request comprises:
automatically reporting the clinical data and associated metadata in statistic analysis software (SAS) format.
